(19) United States
(12) Patent Application Publication
(10) Pub. No.: US 2025/0353283 A1
(43) Pub. Date: Nov. 20, 2025

(54) RECYCLABLE LAMINATED POLYOLEFIN-BASED FILM STRUCTURES

(71) Applicant: PROAMPAC HOLDINGS INC., Cincinnati, NH (US)

(72) Inventors: Zahra Kordjazi, Montreal (CA); Manuel Jaggi, Urtenen-Schönbühl (CH); Seyed Hesamoddin Tabatabaei, Mason, OH (US); Amir Saffar, Laval (CA)

(21) Appl. No.: 19/206,251

(22) Filed: May 13, 2025

Related U.S. Application Data
(60) Provisional application No. 63/648,697, filed on May 17, 2024.

(51) Int. Cl. B32B 27/32; B32B 7/12; B32B 27/08; B32B 33/00; B32B 37/14; B32B 37/16; B32B 38/00

(52) U.S. Cl. CPC B32B 27/32; B32B 7/12; B32B 27/08; B32B 33/00; B32B 37/16; B32B 38/145; B32B 2037/148; B32B 2250/03; B32B 2255/10; B32B 2255/20; B32B 2255/26; B32B 2307/70; B32B 2307/7244; B32B 2307/7246; B32B 2323/046; B32B 2323/10

(57) ABSTRACT

A recyclable, laminated polyolefin film structure comprises two or more film plies laminated to each other. Each ply comprises one or more polyolefin polymers selected from the group consisting of polyolefin homopolymers, copolymers, and terpolymers and mixtures thereof. One or more of the two or more film plies includes one or more barrier layers.

### CROSS REFERENCE TO RELATED APPLICATION

This application claims the priority benefit of U.S. Provisional Patent Application No. 63/648,697 filed May 17, 2024. The aforementioned application is incorporated herein by reference in its entirety.

### INCORPORATION BY REFERENCE

The entire contents of the following patent applications are incorporated by reference herein in their entirety for all purposes:
U.S. application Ser. No. 17/332,658 filed May 27, 2021, now U.S. Pat. No. 11,535,013.
U.S. application Ser. No. 17/961,708 filed Oct. 7, 2022, now U.S. Pat. No. 11,987,026.
U.S. application Ser. No. 17/963,679 filed Oct. 11, 2022, now U.S. Pat. No. 12,304,181.
U.S. application Ser. No. 18/107,850 filed Feb. 9, 2023, now U.S. Pat. No. 11,945,198.
U.S. application Ser. No. 18/608,352 filed Mar. 18, 2024, now pending.
U.S. application Ser. No. 18/665,351 filed May 15, 2024, now U.S. Pat. No. 12,291,010.

### BACKGROUND

The present disclosure relates to laminated polyolefin-based film structures, and more particularly, to laminated polyolefin-based film structures comprising two or more polyolefin-based film ply layers laminated to each other. Each of the laminated films comprises one or more polyolefin-based film layers. The film structures herein have at least two barrier layers, which may be a barrier coating layer or a barrier sublayer within a coextruded multilayer film. In embodiments a printed ink layer is provided on an interior or exterior surface of one of the polyolefin-based film layers. The film structures in accordance with this disclosure may advantageously be adapted to provide a recyclable polyolefin-based film structure for flexible film packaging. In certain embodiments, the film structures herein are polyethylene-based film structures. In certain embodiments, the film structures herein are polypropylene-based film structures.

The film structures disclosed herein may advantageously be used as flexible packaging films that are formed into packages, e.g. pouches, bags, overwraps, and the like, that protect consumable products from spoiling or prematurely degrading in various environments throughout the distribution and point of sale channels. Such packaging structures may be used for packaging of food items, liquids, chemicals, health and beauty products, pharmaceutical products, or other consumable product that needs to be protected from oxygen and moisture throughout the distribution channel environment.

### SUMMARY

In one aspect, a recyclable, laminated polyolefin film structure comprises a first film ply comprising a first polyolefin film comprising one or more polyolefin polymers selected from the group consisting of polyolefin homopolymers, copolymers, and terpolymers and mixtures thereof. The first polyolefin film has a first surface and a second surface opposite the first surface. A second film ply comprises a second polyolefin film comprising one or more polyolefin polymers selected from the group consisting of polyolefin homopolymers, copolymers, and terpolymers and mixtures thereof, the second polyolefin film having a multilayer structure, wherein the second polyolefin film comprises a first surface and a second surface opposite the first surface. The second surface of the second polyolefin film comprises a sealant layer and defining an innermost surface of the laminated polyolefin film. An adhesive layer is interposed between the first film ply and the second film ply, the adhesive layer laminating the first film ply to the third film ply, wherein the first surface of the second polyolefin film faces the first surface of the first polyolefin film. The first film ply, the second film ply, or both, include one or more barrier layers.

In a more limited aspect, the one or more barrier layers comprises a first barrier coating layer on the first polyolefin film and a second barrier coating layer on the second polyolefin film.

In another more limited aspect, the first barrier coating layer is disposed on at least one of the first surface and the second surface of the first polyolefin film and the second barrier coating layer is disposed on at least one of the first surface and the second surface of the second polyolefin film.

In another more limited aspect, the first and second barrier coating layers, which may be the same or different, are selected from the group consisting of (a) an organic barrier coating layer and (b) an inorganic barrier coating layer selected from the group consisting of a metal oxide coating layer and a metalized coating layer.

In another more limited aspect, the first and second barrier coating layers are selected from the group consisting of aluminum oxide and polyvinyl alcohol (PVOH).

In another more limited aspect, the first polyolefin film comprises a first coextruded film and the second polyolefin film comprises a second coextruded film, and wherein the one or more barrier layers comprises a first polymer barrier sublayer of the first coextruded film and a second polymer barrier sublayer of the second coextruded film.

In another more limited aspect, the first and second polymer barrier sublayers, which may be the same or different, are formed of a polymer selected from the group consisting of ethylene-vinyl alcohol (EVOH), polyvinyl alcohol (PVOH), and a polyamide.

In another more limited aspect, the first and second polymer barrier sublayers are formed of EVOH.

In another more limited aspect, the first polyolefin film comprises a coextruded film, and wherein the one or more barrier layers comprises a polymer barrier sublayer of the coextruded film and a barrier coating layer disposed on the second polyolefin film.

In another more limited aspect, the barrier coating layer is selected from the group consisting of (a) an organic barrier coating layer and (b) an inorganic barrier coating layer selected from the group consisting of a metal oxide coating layer and a metalized coating layer; and wherein the polymer barrier sublayer is formed of a polymer selected from the group consisting of ethylene-vinyl alcohol (EVOH), polyvinyl alcohol (PVOH), and a polyamide.

In another more limited aspect, the barrier coating layer is selected from the group consisting of aluminum oxide and polyvinyl alcohol (PVOH), and wherein the polymer barrier sublayer is formed of EVOH.

In another more limited aspect, the second polyolefin film comprises a coextruded film, and wherein the one or more barrier layers comprises a barrier coating layer disposed on the first polyolefin film and a polymer barrier sublayer of the coextruded film.

In another more limited aspect, the barrier coating layer is selected from the group consisting of (a) an organic barrier coating layer and (b) an inorganic barrier coating layer selected from the group consisting of a metal oxide coating layer and a metalized coating layer, and wherein the polymer barrier sublayer is formed of a polymer selected from the group consisting of ethylene-vinyl alcohol (EVOH), polyvinyl alcohol (PVOH), and a polyamide.

In another more limited aspect, the barrier coating layer is selected from the group consisting of aluminum oxide and polyvinyl alcohol (PVOH), and wherein the polymer barrier sublayer is formed of EVOH.

In another more limited aspect, the first polyolefin film comprises a coextruded film, and wherein the one or more barrier layers comprises a polymer barrier sublayer of the coextruded film and a barrier coating layer disposed on at least one of the first and second surfaces of the first polyolefin film.

In another more limited aspect, the barrier coating layer is selected from the group consisting of (a) an organic barrier coating layer and (b) an inorganic barrier coating layer selected from the group consisting of a metal oxide coating layer and a metalized coating layer, and wherein the polymer barrier sublayer is formed of a polymer selected from the group consisting of ethylene-vinyl alcohol (EVOH), polyvinyl alcohol (PVOH), and a polyamide.

In another more limited aspect, the barrier coating layer is selected from the group consisting of aluminum oxide and polyvinyl alcohol (PVOH), and wherein the polymer barrier sublayer is formed of EVOH.

In another more limited aspect, the second polyolefin film comprises a coextruded film, and wherein the one or more barrier layers comprises a polymer barrier sublayer of the coextruded film and a barrier coating layer disposed on a surface of the second polyolefin film.

In another more limited aspect, the barrier coating layer is selected from the group consisting of (a) an organic barrier coating layer and (b) an inorganic barrier coating layer selected from the group consisting of a metal oxide coating layer and a metalized coating layer, and wherein the polymer barrier sublayer is formed of a polymer selected from the group consisting of ethylene-vinyl alcohol (EVOH), polyvinyl alcohol (PVOH), and a polyamide.

In another more limited aspect, the barrier coating layer is selected from the group consisting of aluminum oxide and polyvinyl alcohol (PVOH), and wherein the polymer barrier sublayer is formed of EVOH.

In another more limited aspect, the laminated polyolefin film further comprises a printed layer disposed intermediate the first polyolefin film and the second polyolefin film.

In another more limited aspect, the printed layer comprises a reverse printed ink layer disposed on the second surface of the first polyolefin film.

In another more limited aspect, a package formed of the laminated polyolefin film structure is provided.

In another aspect, a recyclable, laminated polyolefin film structure comprises a first film ply comprising a first polyolefin film comprising one or more polyolefin polymers selected from the group consisting of polyolefin homopolymers, copolymers, and terpolymers and mixtures thereof. The first polyolefin film has a first surface and a second surface opposite the first surface. A second film ply comprises a second polyolefin film comprising one or more polyolefin polymers selected from the group consisting of polyolefin homopolymers, copolymers, and terpolymers and mixtures thereof. The second polyolefin film has a multilayer structure, wherein the second polyolefin film comprises a first surface and a second surface opposite the first surface, the second surface of the second polyolefin film comprising a sealant layer and defining an innermost surface of the laminated polyolefin film. A third film ply is interposed between the first film ply and the second film ply, the third film ply comprising a third polyolefin film comprising one or more polyolefin polymers selected from the group consisting of polyolefin homopolymers, copolymers, and terpolymers and mixtures thereof, the third polyolefin film having a first surface and a second surface opposite the first surface. A first adhesive layer is interposed between the first film ply and the third film ply, the first adhesive layer laminating the first film ply to the third film ply, wherein the first surface of the third polyolefin film faces the second surface of the first polyolefin film. A second adhesive layer is interposed between the third film ply and the second film ply, the second adhesive layer laminating the third film ply to the second film ply, wherein the first surface of the second polyolefin film faces the second surface of the third polyolefin film. One or more of the first film ply, the second film ply, and the third film ply includes one or more barrier layers.

In another more limited aspect, the one or more barrier layers comprises a first barrier coating layer on the third polyolefin film and a second barrier coating layer on the second polyolefin film.

In another more limited aspect, the first barrier coating layer is disposed on at least one of the first surface and the second surface of the third polyolefin film and the second barrier coating layer is disposed on at least one of the first surface and the second surface of the second polyolefin film.

In another more limited aspect, the first and second barrier coating layers, which may be the same or different, are selected from the group consisting of (a) an organic barrier coating layer and (b) an inorganic barrier coating layer selected from the group consisting of a metal oxide coating layer and a metalized coating layer.

In another more limited aspect, the first and second barrier coating layers are selected from the group consisting of aluminum oxide and polyvinyl alcohol (PVOH).

In another more limited aspect, the third polyolefin film comprises a first coextruded film and the second polyolefin film comprises a second coextruded film, and wherein the one or more barrier layers comprises a first polymer barrier sublayer of the first coextruded film and a second polymer barrier sublayer of the second coextruded film.

In another more limited aspect, the first and second polymer barrier sublayers, which may be the same or different, are formed of a polymer selected from the group consisting of ethylene-vinyl alcohol (EVOH), polyvinyl alcohol (PVOH), and a polyamide.

In another more limited aspect, the first and second polymer barrier sublayers are formed of EVOH.

In another more limited aspect, the third polyolefin film comprises a coextruded film, and wherein the one or more barrier layers comprises a polymer barrier sublayer of the coextruded film and a barrier coating layer disposed on the second polyolefin film.

In another more limited aspect, the barrier coating layer is selected from the group consisting of (a) an organic barrier coating layer and (b) an inorganic barrier coating layer selected from the group consisting of a metal oxide coating layer and a metalized coating layer, and wherein the polymer barrier sublayer is formed of a polymer selected from the group consisting of ethylene-vinyl alcohol (EVOH), polyvinyl alcohol (PVOH), and a polyamide.

In another more limited aspect, the barrier coating layer is selected from the group consisting of aluminum oxide and polyvinyl alcohol (PVOH), and wherein the polymer barrier sublayer is formed of EVOH.

In another more limited aspect, the second polyolefin film comprises a coextruded film, and wherein the one or more barrier layers comprises a barrier coating layer disposed on the third polyolefin film and a polymer barrier sublayer of the coextruded film.

In another more limited aspect, the barrier coating layer is selected from the group consisting of (a) an organic barrier coating layer and (b) an inorganic barrier coating layer selected from the group consisting of a metal oxide coating layer and a metalized coating layer, and wherein the polymer barrier sublayer is formed of a polymer selected from the group consisting of ethylene-vinyl alcohol (EVOH), polyvinyl alcohol (PVOH), and a polyamide.

In another more limited aspect, the barrier coating layer is selected from the group consisting of aluminum oxide and polyvinyl alcohol (PVOH), and wherein the polymer barrier sublayer is formed of EVOH.

In another more limited aspect, the third polyolefin film comprises a coextruded film, and wherein the one or more barrier layers comprises a polymer barrier sublayer of the coextruded film and a barrier coating layer disposed on at least one of the first and second surfaces of the third polyolefin film.

In another more limited aspect, the barrier coating layer is selected from the group consisting of (a) an organic barrier coating layer and (b) an inorganic barrier coating layer selected from the group consisting of a metal oxide coating layer and a metalized coating layer, and wherein the polymer barrier sublayer is formed of a polymer selected from the group consisting of ethylene-vinyl alcohol (EVOH), polyvinyl alcohol (PVOH), and a polyamide.

In another more limited aspect, the barrier coating layer is selected from the group consisting of aluminum oxide and polyvinyl alcohol (PVOH), and wherein the polymer barrier sublayer is formed of EVOH.

In another more limited aspect, a package formed of the laminated polyolefin film structure is provided.

One advantage of the present development is that the laminated polyolefin-based film structures exhibit high or ultrahigh barrier properties.

Another advantage of the present development resides in its utility in the manufacture of film-based packaging.

Another advantage resides in its ability to provide a multi-web recyclable polyolefin-based film package.

Still further advantages and benefits of the present invention will become apparent to those of ordinary skill in the art upon reading and understanding the following detailed description of the preferred embodiments.

### BRIEF DESCRIPTION OF THE DRAWING

The invention may take form in various components and arrangements of components, and in various steps and arrangements of steps. The drawings, which are not to scale, are only for purposes of illustrating preferred embodiments and are not to be construed as limiting the invention.

FIG. 1 is a side cross sectional view of a first embodiment laminated film structure comprising two polyolefin-based films laminated together.

FIG. 2 is a side cross sectional view of a second embodiment laminated film structure comprising two polyolefin-based films laminated together.

FIG. 3 is a side cross sectional view of a third embodiment laminated film structure comprising three polyolefin-based films laminated together.

FIG. 4 is a side cross sectional view of a fourth embodiment laminated film structure comprising three polyolefin-based films laminated together.

FIG. 5 is a side cross sectional view of a fifth embodiment laminated film structure comprising three polyolefin-based films laminated together.

FIG. 6 is a side cross sectional view of a sixth embodiment laminated film structure comprising three polyolefin-based films laminated together.

FIG. 7 is a side cross-sectional view of a seventh embodiment laminated film structure comprising four or more polyolefin-based films laminated together.

FIG. 8 illustrates an exemplary polyolefin-based film employing the film structures herein.

FIGS. 9-11 illustrate exemplary multilayer polyolefin-based film structures employing the film structures herein.

FIGS. 12-25 illustrate exemplary laminated film structure having multiple barrier layers.

### DETAILED DESCRIPTION OF THE PREFERRED EMBODIMENTS

Detailed embodiments of the present development are disclosed herein; however, it is to be understood that the disclosed embodiments are merely exemplary of the invention, which may be embodied in various forms. Therefore, specific structural and functional details disclosed herein are not to be interpreted as limiting but merely as a basis for the claims and as a representative basis for teaching one skilled in the art to variously employ the present inventive concept in virtually any appropriately detailed structure. Further, the terms and phrases used herein are not intended to be limiting but rather to provide an understandable description of the present development.

The terms “a” or “an,” as used herein, are defined as one or more than one. The term “another,” as used herein, is defined as at least a second or more. The terms “including” and/or “having” as used herein, are defined as comprising (i.e., open transition). The term “coupled” or “operatively coupled,” as used herein, is defined as indirectly or directly connected.

The present development relates to laminated polyolefin-based film structures comprising two or more polyolefin-based films laminated together.

In certain embodiments, the present development relates to laminated polyethylene-based film structures comprising two or more polyethylene-based films laminated together.

In certain embodiments, the present development relates to laminated polypropylene-based film structures comprising two or more polypropylene-based films laminated together.

As used herein, the term “polyolefin-based film” refers to a film which contains at least 80% by weight polyolefin polymers and less than 20% by weight other polymer materials. The term “polyolefin polymer” includes polyolefin homopolymers, copolymers, terpolymers, or combinations thereof. The term “polyolefin-based film” further encompasses composite or multilayer films where individual plies or layers may deviate from this 80:20 ratio, provided that the overall weight ratio of polyolefin polymers to other polymer materials meets or exceeds the 80:20 threshold. In certain more limited embodiments, the polyolefin-based films herein contain at least 90% by weight polyolefin polymers and less than 10% by weight other polymer materials, including composite or multilayer films where individual plies or layers may deviate from this 90:10 ratio, provided that the overall weight ratio of polyolefin polymers to other polymer materials meets or exceeds the 90:10 threshold.

As used herein, the term “polyethylene-based film” refers to a film which contains at least 80% by weight polyethylene polymers and less than 20% by weight other polymer materials. The term “polyethylene polymer” includes polyethylene homopolymers, copolymers, terpolymers, or combinations thereof. The term “polyethylene-based film” further encompasses composite or multilayer films where individual plies or layers may deviate from this 80:20 ratio, provided that the overall weight ratio of polyethylene polymers to other polymer materials meets or exceeds the 80:20 threshold. In certain more limited embodiments, the polyethylene-based films herein contain at least 90% by weight polyethylene-based polymers and less than 10% by weight other polymer materials, including composite or multilayer films where individual plies or layers may deviate from this 90:10 ratio, provided that the overall weight ratio of polyethylene polymers to other polymer materials meets or exceeds the 90:10 threshold.

As used herein, the term “polypropylene-based film” refers to a film which contains at least 80% by weight polypropylene polymers and less than 20% by weight other polymer materials. The term “polypropylene polymer” includes polypropylene homopolymers, copolymers, terpolymers, or combinations thereof. The term “polypropylene-based film” further encompasses composite or multilayer films where individual plies or layers may deviate from this 80:20 ratio, provided that the overall weight ratio of polypropylene polymers to other polymer materials meets or exceeds the 80:20 threshold. In certain more limited embodiments, the polypropylene-based films herein contain at least 90% by weight polypropylene-based polymers and less than 10% by weight other polymer materials, including composite or multilayer films where individual plies or layers may deviate from this 90:10 ratio, provided that the overall weight ratio of polypropylene polymers to other polymer materials meets or exceeds the 90:10 threshold.

As used herein, the term “recyclable” may refer to a product that is compatible with polyolefin, polyethylene, and/or polypropylene collection streams, including materials that comply with one or more promulgated standards or guidelines for recyclability, and including materials that are sufficiently free of other materials, such as polyethylene terephthalate (PET), polyvinyl chloride (PVC), polyvinylidene chloride (PVDC), paper, aluminum foil, and other materials which would impede recyclability.

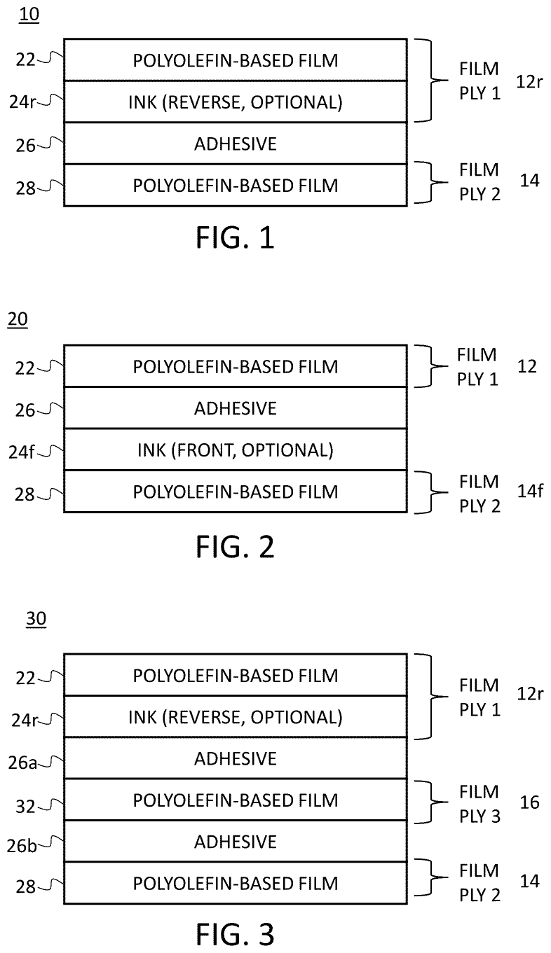

Referring now to the drawings, FIGS. 1-14 illustrate exemplary polyolefin-based packaging film structures manufactured in accordance with exemplary embodiments of the present invention. In embodiments, the packaging film structures illustrated have enhanced heat resistance properties. With respect to the figures, like reference numerals are used to describe like or analogous items. The description in reference to any given reference numeral in one embodiment herein is equally applicable to the other embodiments, unless specifically stated otherwise.

Referring now to FIG. 1, there appears a first embodiment packaging film structure 10 which includes a first film ply 12r laminated to a second film ply 14. The first film ply 12r is an outer film and the second film ply is an inner film. An adhesive layer 26 is interposed between the first film ply 12r and the second film ply 14 to form a laminated structure. The adhesive layer 26 may be formed of any suitable adhesive, including single component adhesives, two component adhesives, solvent-based adhesives, solventless adhesives, water-based adhesives, acrylic adhesives, extruded polyethylene or polypropylene adhesive systems, electron beam lamination adhesives, and UV lamination adhesives, as would be understood by persons skilled in the art.

The first film ply 12r is formed on an outer portion of the packaging film structure 10. The film 12r includes a polyolefin-based film 22, which may be a monolayer or multilayer structure. Exemplary polyolefin polymers forming the polyolefin-based film 22 include, for example, homopolymers, copolymers, and terpolymers of ethylene, high density polyethylene (HDPE), medium density polyethylene (MDPE), linear medium density polyethylene (LMDPE), low density polyethylene (LDPE), linear low density polyethylene (LLDPE), very low density polyethylene (VLDPE), metallocene linear low-density polyethylene (mLLDPE), and homopolymers, copolymers, and terpolymers of polypropylene.

In certain embodiments, a printing ink layer 24r is disposed on a second, inward facing surface of the polyolefin-based film 22, the second surface opposite the first surface. The printing ink layer 24r provides printed indicia intended to appear on a packaging structure formed from the film structure 10. Because the printing ink layer 24r is applied to the inward facing surface of the polyolefin-based film 22, the printed material is effected in a reverse printed format. The printing ink layer 24r can be applied to the second surface of the polyolefin-based film 22 via any conventional printing method as would be understood by persons skilled in the art, including without limitation, using a rotogravure printing apparatus or flexographic printing apparatus.

The second film ply 14 includes a polyolefin-based film 28 formed on an innermost portion of the film structure 10. The polyolefin-based film 28 defines a sealant layer and may comprise any polyolefin polymer suitable for providing a hermetic seal in a finished packaging article, and preferably has a low seal initiation temperature/melting temperature. The polyolefin-based film 28 may be a monolayer or multilayer structure. Exemplary polyolefin polymers forming the polyolefin-based film 28 include, for example, homopolymers, copolymers, and terpolymers of ethylene, high density polyethylene (HDPE), medium density polyethylene (MDPE), linear medium density polyethylene (LMDPE), low density polyethylene (LDPE), linear low density polyethylene (LLDPE), very low density polyethylene (VLDPE), metallocene linear low-density polyethylene (mLLDPE), and homopolymers, copolymers, and terpolymers of polypropylene.

Referring now to FIG. 2, there appears a second embodiment packaging film structure 20 which includes a first film ply 12 laminated to a second film ply 14f. The first film ply 12 is an outer film and the second film ply 14f is an inner film. An adhesive layer 26 is interposed between the first film ply 12 and the second film ply 14f to form a laminated structure. The adhesive layer 26 may be formed of an adhesive material as described above by way of reference to FIG. 1.

The first film ply 12 is formed on an outer portion of the packaging film structure 20. The first film ply 12 includes a polyolefin-based film 22, which may be a monolayer or multilayer structure and may be formed of a polyolefin-based film as described above by way of reference to FIG. 1.

The second film ply 14f includes a polyolefin-based film 28 and is formed on an innermost portion of the film structure 20. The polyolefin-based film 28 defines a sealant layer and may comprise any polyolefin polymer suitable for providing a hermetic seal in a finished packaging article, and preferably has a low seal initiation temperature/melting temperature. The polyolefin-based film 28, which may be a monolayer or multilayer structure, may comprise a polyolefin polymer material as described above by way of reference to FIG. 1. In certain embodiments, the polyolefin-based film 28 is formed of low density polyethylene (LDPE) or linear low density polyethylene (LLDPE).

The second film ply 14f further includes a printing ink layer 24f disposed on a first, outward facing surface of the polyolefin-based film 22. The printing ink layer 24f provides printed indicia intended to appear on a packaging structure formed from the film structure 20. Because the printing ink layer 24f is applied to the outward facing surface of the polyolefin-based film 22, the printed material is effected in a front printed format. The printing ink layer 24f can be applied to the first surface of the polyolefin-based film 22 via any conventional printing method as would be understood by persons skilled in the art, including without limitation, using a rotogravure printing apparatus or flexographic printing apparatus.

Referring now to FIG. 3, there appears a third embodiment packaging film structure 30, comprising a first film ply 12r, a third film ply 16, and a second film ply 14, which are laminated together. The first film ply 12r is an outer film, the second film ply is an inner film, and the third film ply is an intermediate film. A first adhesive layer 26a is interposed between the first film ply 12r and the third film ply 16 and a second adhesive layer 26b is interposed between the third film ply 16 and the second film ply 14, to form a laminated structure. The adhesive layers 26a and 26b may be formed of an adhesive material as described above by way of reference to FIG. 1.

The first film ply 12r is formed on an outer portion of the packaging film structure 30. The film 12r includes a polyolefin-based film 22, which may be a monolayer or structure, and may comprise a polyolefin polymer material as described above by way of reference to FIG. 1.

A printing ink layer 24r is disposed on a second, inward facing surface of the polyolefin-based film 22, opposite the first surface. The printing ink layer 24r provides printed indicia intended to appear on a packaging structure formed from the film structure 30. Because the printing ink layer 24r is applied to the inward facing surface of the polyolefin-based film 22, the printed material is effected in a reverse printed format. The printing ink layer 24r can be applied to the second surface of the polyolefin-based film 22 via any conventional printing method as would be understood by persons skilled in the art, including without limitation, using a rotogravure printing apparatus or flexographic printing apparatus.

The second film ply 14 includes a polyolefin-based film 28 and is formed on an innermost portion of the film structure 30. The polyolefin-based film 28 defines a sealant layer and may comprise any polyolefin polymer suitable for providing a hermetic seal in a finished packaging article, and preferably has a low seal initiation temperature/melting temperature. The polyolefin-based film 28, which may be a monolayer or multilayer structure, may comprise a polyolefin polymer material as described above by way of reference to FIG. 1. In certain embodiments, the polyolefin-based film 28 is formed of low density polyethylene (LDPE) or linear low density polyethylene (LLDPE).

The third film ply 16 is interposed between the first film ply 12r and the second film ply 14. The third film ply 16 includes a polyolefin-based film 32, which may be a monolayer or multilayer structure. The polyolefin-based film 32 may be a monolayer or multilayer structure. Exemplary polyolefin polymers for forming the polyolefin-based film 32 include, for example, homopolymers, copolymers, and terpolymers of ethylene, high density polyethylene (HDPE), medium density polyethylene (MDPE), linear medium density polyethylene (LMDPE), low density polyethylene (LDPE), linear low density polyethylene (LLDPE), very low density polyethylene (VLDPE), metallocene linear low-density polyethylene (mLLDPE), and homopolymers, copolymers, and terpolymers of polypropylene.

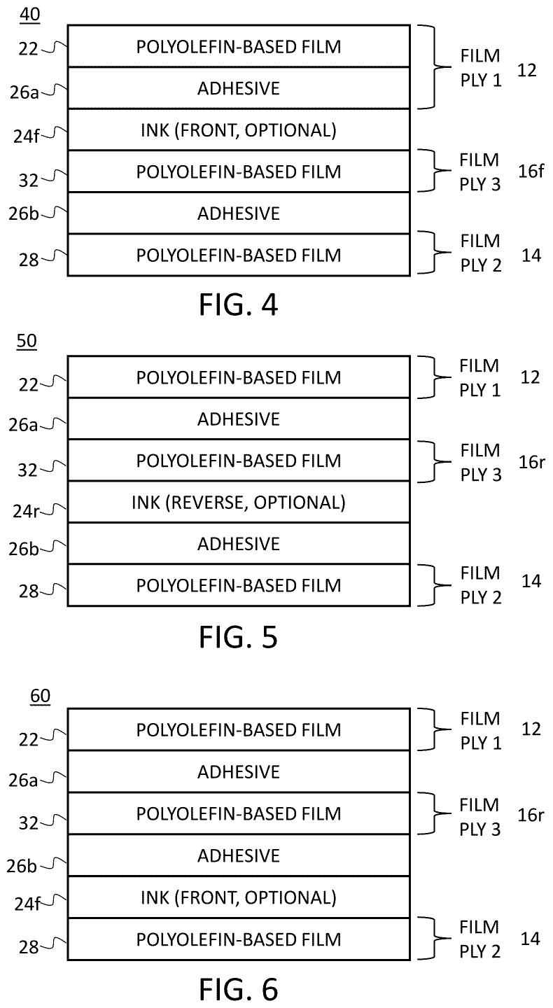

Referring now to FIG. 4, there appears a fourth embodiment packaging film structure 40, comprising a first film ply 12, a third film ply 16f, and a second film ply 14, which are laminated together. The first film ply 12 is an outer film, the second film ply is an inner film, and the third film ply is an intermediate film. A first adhesive layer 26a is interposed between the first film ply 12 and the third film ply 16f and a second adhesive layer 26b is interposed between the third film ply 16f and the second film ply 14, to form a laminated structure. The adhesive layers 26a and 26b may be formed of an adhesive material as described above by way of reference to FIG. 1.

The first film ply 12 is formed on an outer portion of the packaging film structure 40. The film 12 includes a polyolefin-based film 22, which may be a monolayer or multilayer structure and which may comprise a polyolefin polymer as described above by way of reference to FIG. 1.

The second film ply 14 includes a polyolefin-based film 28 and is formed on an innermost portion of the film structure 40. The polyolefin-based film 28 defines a sealant layer and may comprise any polyolefin polymer suitable for providing a hermetic seal in a finished packaging article, and preferably has a low seal initiation temperature/melting temperature. The polyolefin-based film 28, which may be a monolayer or multilayer structure, may be formed of a polyolefin polymer material as described above by way of reference to FIG. 1. In certain embodiments, the polyolefin-based film 28 is formed of low density polyethylene (LDPE) or linear low density polyethylene (LLDPE).

The third film ply 16f is interposed between the first film ply 12 and the second film ply 14. The third film ply 16f includes a polyolefin-based film 32, which may be a monolayer or multilayer structure. The polyolefin-based film 32 may comprise a polyolefin polymer material as described above by way of reference to FIG. 3.

The third film ply 16f further includes a printing ink layer 24f disposed on a first, outward facing surface of the polyolefin-based film 32. The printing ink layer 24f provides printed indicia intended to appear on a packaging structure formed from the film structure 40. Because the printing ink layer 24f is applied to the outward facing surface of the polyolefin-based film 32, the printed material is effected in a front printed format. The printing ink layer 24f can be applied to the first surface of the polyolefin-based film 32 via any conventional printing method as would be understood by persons skilled in the art, including without limitation, using a rotogravure printing apparatus or flexographic printing apparatus.

Referring now to FIG. 5, there appears a fifth embodiment packaging film structure 50 comprising a first film ply 12, a third film ply 16r, and a second film ply 14, which are laminated together. The first film ply 12 is an outer film, the second film ply is an inner film, and the third film ply is an intermediate film. A first adhesive layer 26a is interposed between the first film ply 12 and the third film ply 16r and a second adhesive layer 26b is interposed between the third film ply 16r and the second film ply 14, to form a laminated structure. The adhesive layers 26a and 26b may be formed of an adhesive material as described above by way of reference to FIG. 1.

The first film ply 12 is formed on an outer portion of the packaging film structure 50. The film 12 includes a polyolefin-based film 22, which may be a monolayer or multilayer structure, and may comprise of a polyolefin polymer material as described above by way of reference to FIG. 1.

The second film ply 14 includes a polyolefin-based film 28 and is formed on an innermost portion of the film structure 50. The polyolefin-based film 28 defines a sealant layer and comprise any polyolefin polymer suitable for providing a hermetic seal in a finished packaging article, and preferably has a low seal initiation temperature/melting temperature. The polyolefin-based film 28, which may be a monolayer or multilayer structure, may be formed of a polyolefin polymer material as described above by way of reference to FIG. 1. In certain embodiments, the polyolefin-based film 28 is formed of low density polyethylene (LDPE) or linear low density polyethylene (LLDPE).

The third film ply 16r is interposed between the first film ply 12 and the second film ply 14. The third film ply 16r includes a polyolefin-based film 32, which may be a monolayer or multilayer structure. The polyolefin-based film 32 may comprise a polyolefin polymer material as described above by way of reference to FIG. 3.

The third film ply 16r further includes a printing ink layer 24r disposed on an inward facing surface of the polyolefin-based film 32. The printing ink layer 24r provides printed indicia intended to appear on a packaging structure formed from the film structure 50. Because the printing ink layer 24r is applied to the inward facing surface of the polyolefin-based film 32, the printed material is effected in a reverse printed format. The printing ink layer 24r can be applied to the inward facing surface of the polyolefin-based film 32 via any conventional printing method as would be understood by persons skilled in the art, including without limitation, using a rotogravure printing apparatus or flexographic printing apparatus.

Referring now to FIG. 6, there appears a sixth embodiment packaging film structure 60, comprising a first film ply 12, a third film ply 16, and a second film ply 14f, which are laminated together. The first film ply 12 is an outer film, the second film ply is an inner film, and the third film ply is an intermediate film. A first adhesive layer 26a is interposed between the first film ply 12 and the third film ply 16 and a second adhesive layer 26b is interposed between the third film ply 16 and the second film ply 14f, to form a laminated structure. The adhesive layers 26a and 26b may be formed of an adhesive material as described above by way of reference to FIG. 1.

The first film ply 12 is formed on an outer portion of the packaging film structure 60. The film 12 includes a polyolefin-based film 22, which may be a monolayer or multilayer structure, and may be formed of a polyolefin polymer material as described above by way of reference to FIG. 1.

The second film ply 14f includes a polyolefin-based film 28 and is formed on an innermost portion of the film structure 60. The polyolefin-based film 28 defines a sealant layer and may comprise any polyolefin polymer suitable for providing a hermetic seal in a finished packaging article, and preferably has a low seal initiation temperature/melting temperature. The polyolefin-based film 28, which may be a monolayer or multilayer structure, may be formed of a polyolefin polymer material as described above by way of reference to FIG. 1. In certain embodiments, the polyolefin-based film 28 is formed of low density polyethylene (LDPE) or linear low density polyethylene (LLDPE).

The third film ply 16 is interposed between the first film ply 12 and the second film ply 14f. The third film ply 16 includes a polyolefin-based film 32, which may be a monolayer or multilayer structure. The polyolefin-based film 32 may comprise a polyolefin polymer material as described above by way of reference to FIG. 3.

A printing ink layer 24f is disposed on an outward facing surface of the polyolefin-based film 32, opposite the innermost surface. The printing ink layer 24f provides printed indicia intended to appear on a packaging structure formed from the film structure 60. Because the printing ink layer 24f is applied to the outward facing surface of the polyolefin-based film 32, the printed material is effected in a front printed format. The printing ink layer 24f can be applied to the outward facing surface of the polyolefin-based film 32 via any conventional printing method as would be understood by persons skilled in the art, including without limitation, using a rotogravure printing apparatus or flexographic printing apparatus.

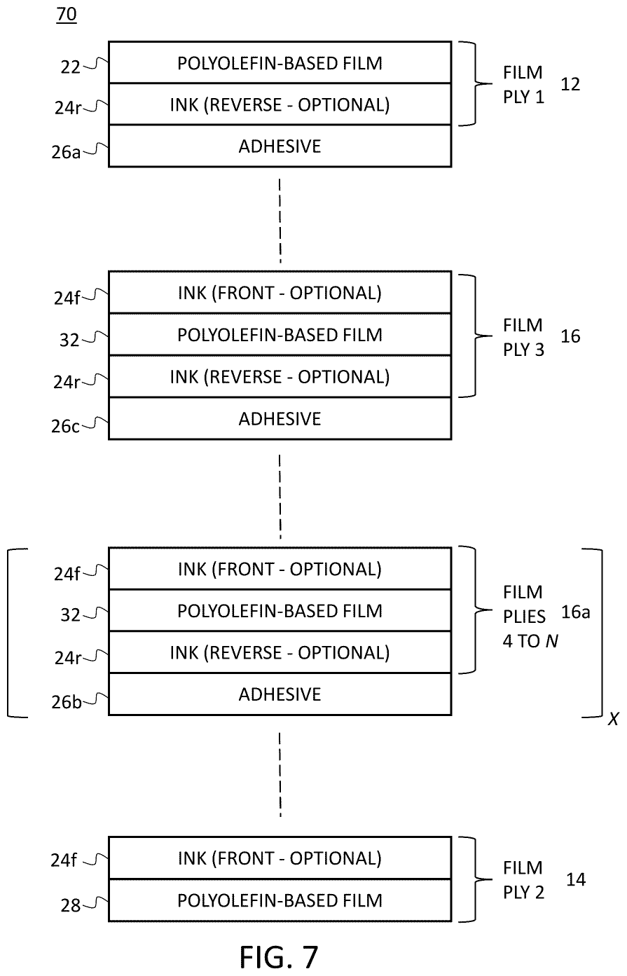

Referring now to FIG. 7, there appears a seventh embodiment packaging film structure 70, comprising a first film ply 12, a third film ply 16, a second film ply 14, and one or more (up to “X”) film plies 4 through N, designated 16a, where X is 1, 2, 3, 4, 5, 6, 7, 8, 9, or more, and N is 4, 5, 6, 7, 8, 9, 10, 11, 12, or more, which are laminated together. The first film ply 12 is an outer film, the second film ply is an inner film, and the third film ply is an intermediate film. A first adhesive layer 26a is interposed between the first film ply 12 and the third film ply 16 and a second adhesive layer 26b is interposed between the third film ply 16 and the fourth film ply 16a, and further adhesive layers 26c are disposed between the fourth and subsequent film plies 16a and the second film ply 14 to form a laminated structure. The adhesive layers 26a, 26b, and 26c may be formed of an adhesive material as described above by way of reference to FIG. 1.

The first film ply 12 is formed on an outer portion of the packaging film structure 70. The film 12 includes a polyolefin-based film 22, which may be a monolayer or multilayer structure, and may comprise a polyolefin polymer material as described above by way of reference to FIG. 1.

The second film ply 14 includes a polyolefin-based film 28 and is formed on an innermost portion of the film structure 70. The polyolefin-based film 28 defines a sealant layer and may be any polyolefin polymer suitable for providing a hermetic seal in a finished packaging article, and preferably has a low seal initiation temperature/melting temperature. The polyolefin-based film 28, which may be a monolayer or multilayer structure, may be formed of a polyolefin polymer material as described above by way of reference to FIG. 1. In certain embodiments, the polyolefin-based film 28 is formed of low density polyethylene (LDPE) or linear low density polyethylene (LLDPE).

The third film ply 16 is interposed between the first film ply 12 and the one or more film plies 16a. The third film ply 16 includes a polyolefin-based film 32, which may be a monolayer or multilayer structure. The polyolefin-based film 32 may comprise a polyolefin polymer material as described above by way of reference to FIG. 3.

The film plie(s) 4 through N 16a are interposed between the third film ply 16 and the second film ply layer 14. The fourth film ply layer(s) 16a include a polyolefin-based film 32a, which may be a monolayer or multilayer structure. The polyolefin-based film 32a may be formed of a polyolefin polymer material as described above by way of reference to FIG. 3.

A printing ink layer 24f or 24r is disposed on an outward or inward facing surface, respectively, of a selected one of the polyolefin-based films 32, 32a, or alternatively, on the inward facing surface of the polyolefin layer 22 or the outward facing surface of the polyolefin layer 28. The printing ink layer 24f, 24r provides printed indicia intended to appear on a packaging structure formed from the film structure 70. The printed material comprising the printing ink layer is effected in a front printed format (24f) or a reverse printed format (24r), depending on whether the printing layer is applied to an outward facing surface or an inward facing surface. The printing ink layer 24f, 24r can be applied via any conventional printing method as would be understood by persons skilled in the art, including without limitation, using a rotogravure printing apparatus or flexographic printing apparatus.

One method of manufacturing a laminated film structure comprises providing a first film ply or web. Printing ink may be applied to one side of a recyclable polyolefin-based film. In all embodiments, an optional coating may be applied to the outer surface of the first film ply. The first film ply is then laminated to a second film ply comprising a recyclable polyolefin-based film web, such that the inks are sandwiched between the webs. In certain embodiments, the steps are performed in a continuous process step. Alternatively, the steps can be performed in separate process steps.

Another method of manufacturing a laminated film structure comprises providing a first polyolefin-based film which forms a first film ply. Printing inks may be applied to the surface of a second polyolefin-based film to form a second film ply. The first and second film plies are then laminated together with an adhesive such that the printing ink layer is disposed on an interior surface of the laminate.

Yet another method of manufacturing a laminated film structure comprises providing a polyolefin-based film which forms an outer film ply. An intermediate film ply comprising a polyolefin-based film and an inner film ply comprising a polyolefin-based film are also provided. The innermost side of the inner film ply defines a sealant layer. A printing ink layer may applied to any one of the inward facing surface of outer film ply, either side of the intermediate film ply, or the outward facing surface of the inner film ply. The outer, intermediate, and inner film plies are then laminated together, with the intermediate film ply interposed between the outer and inner film plies. This provides a printed ink layer sandwiched within layers.

The present development was reduced to practice and the heat resistance was compared to recyclable polyolefin-based film having no coating or a traditional wet coating cured through ambient or heat airflow. The film structures were tested using a sealing pressure of 40 psi and a sealing dwell time of 0.5 seconds. The sealing temperature ranged from 60 degrees C. to 260 degrees C. Data showing the improved heat resistance of an energy-cured coating on a 2-ply recyclable polyethylene-based film structure in accordance with the present disclosure versus 2-ply film structures with no coating or a traditional wet coating cured through ambient or heat airflow are shown in Table 1.

TABLE 1
Film Heat Resistance Test Results
Conditions: Heat Seal @ 40 psi, 0.5 sec- (seal strength (g/in))

| | Recyclable Lam 2-Ply | Recyclable Lam 2-Ply | Recyclable Lam 2-Ply |
|---|---|---|---|
| | 100 ga PE / 3 mil PE | 90 ga PE / 3 mil PE | 90 ga PE / 3 mil PE |
| Temp (° C.) | Wet Coating | No Coating | Energy-Cured Coating |
| 60 | Inner surface not melted | Inner surface not melted | Inner surface not melted |
| | Outer surface not melted | Outer surface not melted | Outer surface not melted |
| 80 | Inner surface initial melt | Inner surface initial melt | Inner surface initial melt |
| | Outer surface not melted | Outer surface not melted | Outer surface not melted |
| 130 | Inner surface melted | Inner surface melted | Inner surface melted |
| | Outer surface not melted | Outer surface not melted | Outer surface not melted |
| 135 | Inner surface melted | Inner surface melted | Inner surface melted |
| | Outer surface starting to | Outer surface not melted | Outer surface not melted |
| | shrink | | |
| 140 | Inner surface melted | Inner surface melted | Inner surface melted |
| | Outer melt shrink 3 mm in | Outer melted/stick to top | Outer surface not melted |
| | MD/TD | metal jaw | |
| 150 | | | Inner surface melted |
| | | | Outer surface not melted |
| 200 | | | Inner surface melted |
| | | | Outer surface not melted |
| 230 | | | Inner surface melted |
| | | | Outer surface not melted |
| 260 | | | Inner surface melted |
| | | | Outer surface not melted |

Data showing the improved heat resistance of a two-part coating on a 2-ply recyclable polyethylene-based film structure in accordance with the present disclosure versus 2-ply film structures with no coating or a traditional wet coating cured through ambient or heat airflow are shown in Table 2.

TABLE 2
Film Heat Resistance Test Results
Conditions: Heat Seal @ 40 psi, 0.5 sec- (seal strength (g/in))

| | Recyclable Lam 2-Ply | Recyclable Lam 2-Ply | Recyclable Lam 2-Ply |
|---|---|---|---|
| | 100 ga PE / 3 mil PE | 90 ga PE / 3 mil PE | 90 ga PE / 3 mil PE |
| Temp (° C.) | Wet Coating | No Coating | Two-part Coating |
| 60 | Inner surface not melted | Inner surface not melted | Inner surface not melted |
| | Outer surface not melted | Outer surface not melted | Outer surface not melted |
| 80 | Inner surface initial melt | Inner surface initial melt | Inner surface initial melt |
| | Outer surface not melted | Outer surface not melted | Outer surface not melted |
| 130 | Inner surface melted | Inner surface melted | Inner surface melted |
| | Outer surface not melted | Outer surface not melted | Outer surface not melted |
| 135 | Inner surface melted | Inner surface melted | Inner surface melted |
| | Outer surface starting to | Outer surface not melted | Outer surface not melted |
| | shrink | | |
| 140 | Inner surface melted | Inner surface melted | Inner surface melted |
| | Outer melt shrink 3 mm in | Outer melted/stick to top | Outer surface not melted |
| | MD/TD | metal jaw | |
| 150 | | | Inner surface melted |
| | | | Outer surface not melted |
| 200 | | | Inner surface melted |
| | | | Outer surface not melted |
| 230 | | | Inner surface melted |
| | | | Outer surface not melted |
| 240 | | | Inner surface melted |
| | | | Outer melt shrink 3 mm MD/TD |

As can be seen from the data in Table 1, the film structure having the energy-cured coating in accordance with the present development was found to have a temperature differential between inner layer melting and outer layer melting of at least 180 degrees C.; whereas, the film structures without no coating or a traditional dried wet coating had a temperature differential between inner layer melting and outer layer melting of at most 60 degrees C.

As can be seen from the data in Table 2, the film structure having the two-part coating in accordance with the present development was found to have a temperature differential between inner layer melting and outer layer melting of at least 150 degrees C.; whereas, the film structures without no coating or a traditional dried wet coating had a temperature differential between inner layer melting and outer layer melting of at most 60 degrees C.

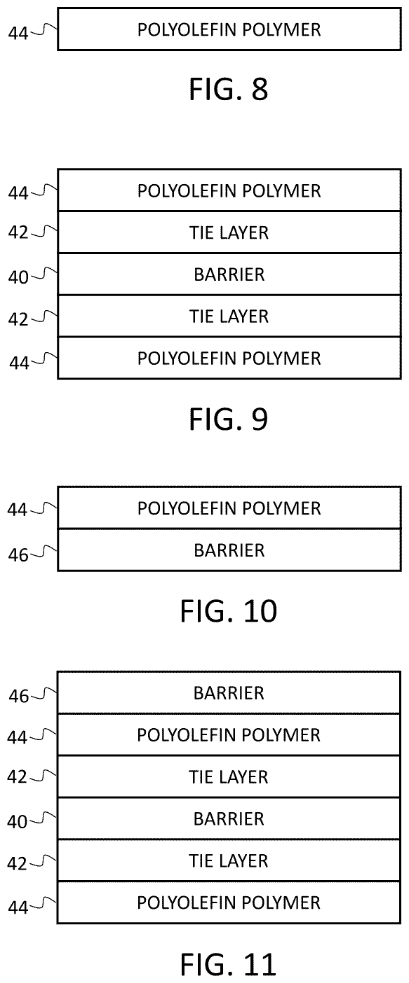

As mentioned above, each of the recyclable polyolefin layers 22, 28, and 32 in the embodiments above, which may be the same or different, may comprise monolayer or multilayer structures. The recyclable polyolefin layers 22, 28, and 32 may be coextrusions, extrusion laminations, laminations, or combinations thereof. In certain embodiments, one or more of the recyclable polyolefin layers 22, 28, and 32 includes a barrier layer for preventing or reducing the transmission of oxygen or other gas molecules or moisture vapor through the film structure. FIGS. 8 and 9 illustrate exemplary polyolefin-based films 22, 28, and 32. FIG. 8 illustrates a polyolefin-based film comprising a polyolefin polymer layer 44, which is operable to embody the polyolefin-based film layers 22, 28, or 32. FIG. 9 illustrates a five-layer polyethylene-based film structure comprising a barrier layer 40 disposed between two polyolefin layers 44. Tie layers 42 are disposed intermediate the barrier layer 40 and each of the polyolefin layers 44. Exemplary tie layers include maleic anhydride (MAH) or other tie resin or adhesion promotor as would be known by persons skilled in the art. Although a 5-layer multilayer film structure is illustrated, it will be recognized that other numbers of layers, including 7 layer, 9-layer, and others are also contemplated. Exemplary barrier layers 40 include polymer barrier layers such as ethylene-vinyl alcohol (EVOH), polyvinyl alcohol (PVOH), polyamides, e.g., polyamide nylon (PA) (e.g., polyamide nylon 6 (PA6)), with or without compatibilizer additives.

Referring now to FIG. 10, in still further embodiments, each of the polyolefin-based film layers 22, 28, and 32, may comprise a monolayer or multilayer polyolefin polymer structure 44 having an organic or inorganic barrier layer 46. Exemplary barrier layers 46 include but are not limited to barrier coating layers, including polymer barrier coating layers, such as EVOH, PVOH, PA, and the like. Exemplary barrier layers 46 also include metal oxide coating layers such as aluminum oxide (AlOx), silicon oxide (SiOx), or combinations thereof. Exemplary barrier layers 46 further include a deposition layer of metal or metal oxide, which can be applied through various methods including physical deposition techniques such as physical vapor deposition (PVD) or chemical deposition techniques such as chemical vapor deposition (CVD). Exemplary metals that may be included in the barrier layer 46 include aluminum, copper, titanium, zinc, iron, and alloys thereof. Exemplary metal oxides that may be included in the barrier layer 46 include include SiOx, AlOx, as well as oxides derived from other metals such as titanium and zinc.

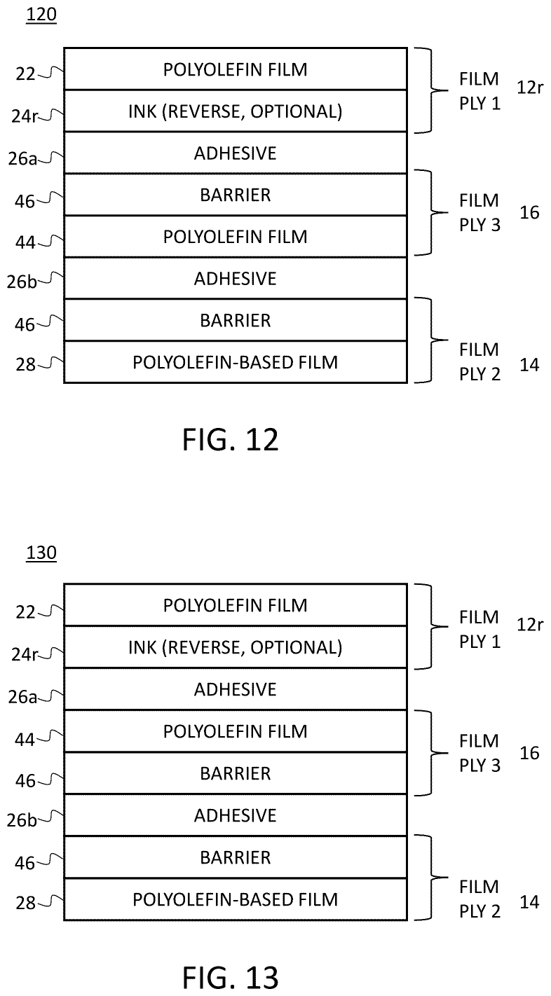

Referring now to FIG. 12, there is shown an exemplary film structure 120 having first, second, and third film plies 12r, 14, and 16, respectively, wherein the third film ply 16 includes a barrier coating layer 46 disposed a first side of a polyolefin layer 44 and the second film ply 14 comprises a barrier coating layer 46 disposed a first side of a polyolefin layer 44.

Referring now to FIG. 13, there is shown an exemplary film structure 130 having first, second, and third film plies 12r, 14, and 16, respectively, wherein the third film ply 16 includes a barrier coating layer 46 disposed a second side of a polyolefin layer 44 and the second film ply 14 comprises a barrier coating layer 46 disposed a first side of a polyolefin layer 44.

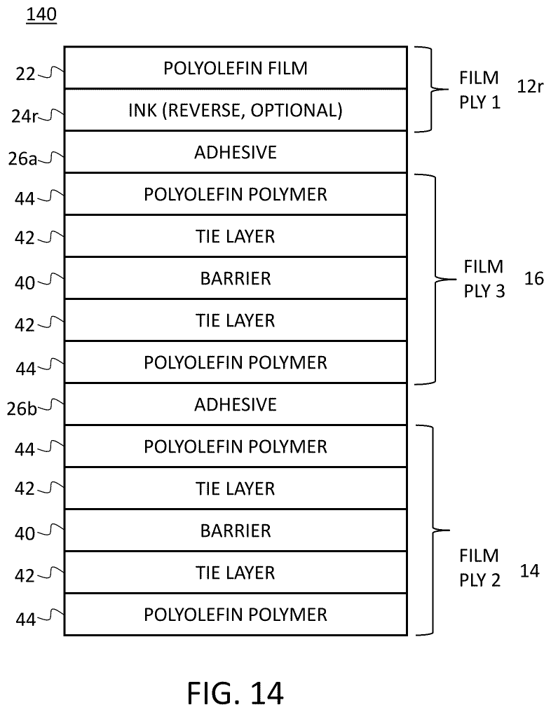

Referring now to FIG. 14, there is shown an exemplary film structure 140 having first, second, and third film plies 12r, 14, and 16, respectively, wherein each of the third film ply 16 and the second film ply 14 are a coextruded film having a polymer barrier sublayer 40 within a multilayer coextruded film.

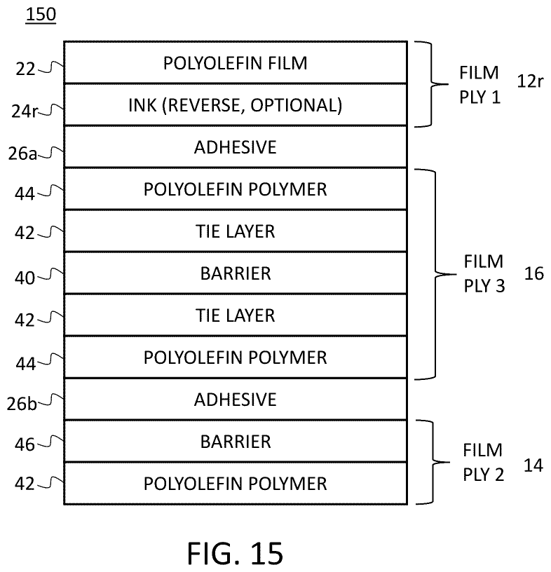

Referring now to FIG. 15, there is shown an exemplary film structure 150 having first, second, and third film plies 12r, 14, and 16, respectively, wherein the third film ply 16 is a coextruded film having a polymer barrier sublayer 40 within a multilayer coextruded film and the second film ply 14 a barrier coating layer 46 disposed a first side of a polyolefin layer 44.

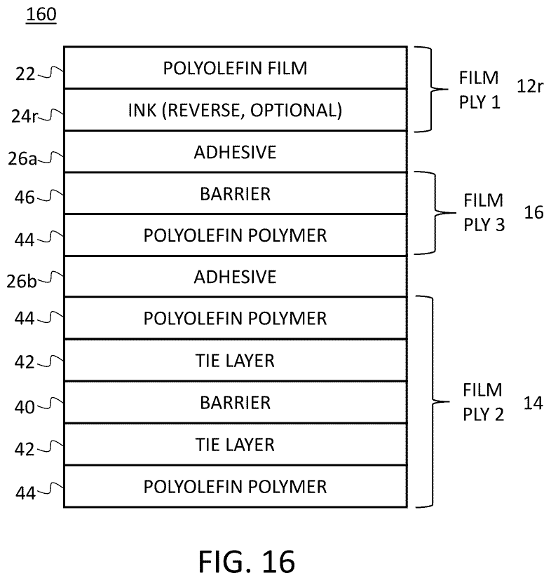

Referring now to FIG. 16, there is shown an exemplary film structure 160 having first, second, and third film plies 12r, 14, and 16, respectively, wherein the second film ply 14 is a coextruded film having a polymer barrier sublayer 40 within a multilayer coextruded film and the third film ply 16 a barrier coating layer 46 disposed a first side of a polyolefin layer 44.

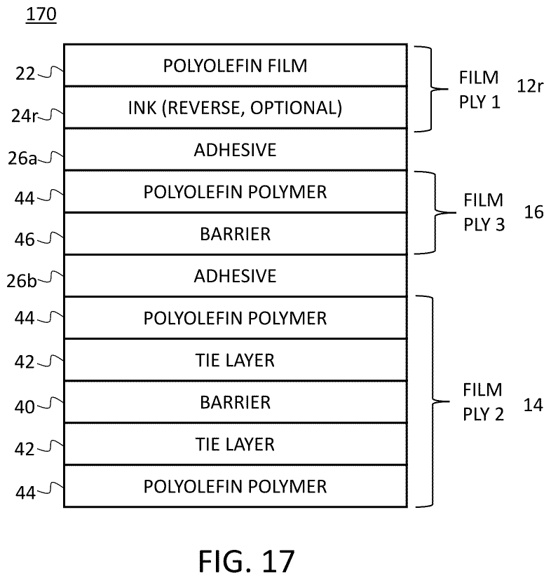

Referring now to FIG. 17, there is shown an exemplary film structure 170 having first, second, and third film plies 12r, 14, and 16, respectively, wherein the second film ply 14 is a coextruded film having a polymer barrier sublayer 40 within a multilayer coextruded film and the third film ply 16 a barrier coating layer 46 disposed a second side of a polyolefin layer 44.

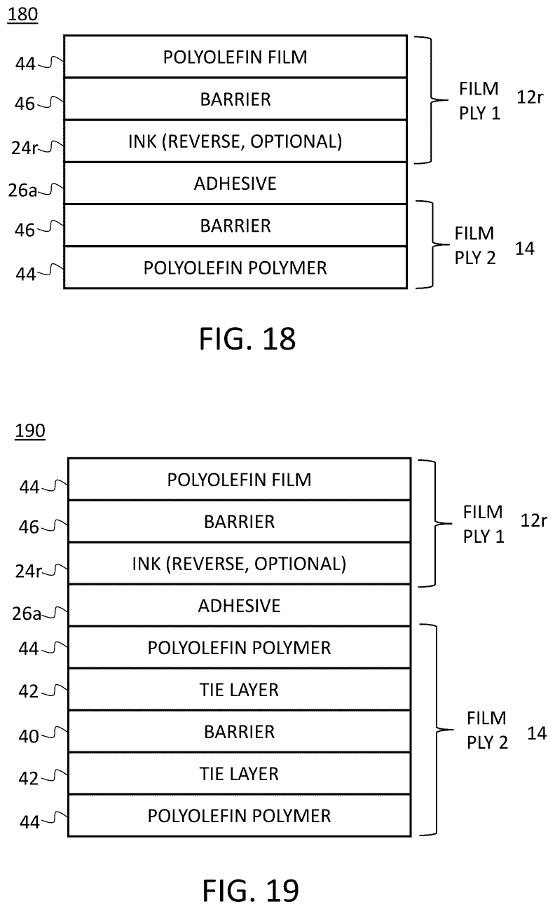

Referring now to FIG. 18, there is shown an exemplary film structure 180 having first, second, film plies 12r and 14, respectively, wherein the second film ply 14 includes a barrier coating layer 46 disposed a first side of a polyolefin layer 44 and the first film ply 12r comprises a barrier coating layer 46 disposed a second side of a polyolefin layer 44.

Referring now to FIG. 19, there is shown an exemplary film structure 190 having first, second, film plies 12r and 14, respectively, wherein the first film ply 12r includes a barrier coating layer 46 disposed a second side of a polyolefin layer 44 and the second film ply 14 is a coextruded film having a polymer barrier sublayer 40 within a multilayer coextruded film.

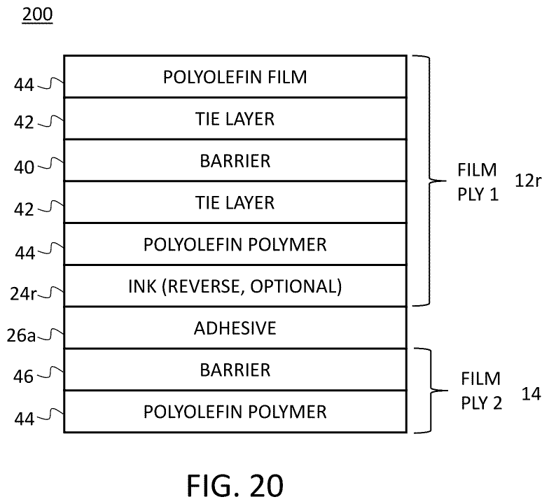

Referring now to FIG. 20, there is shown an exemplary film structure 200 having first, second, film plies 12r and 14, respectively, wherein the second film ply 14 includes a barrier coating layer 46 disposed a first side of a polyolefin layer 44 and the first film ply 12r is a coextruded film having a polymer barrier sublayer 40 within a multilayer coextruded film.

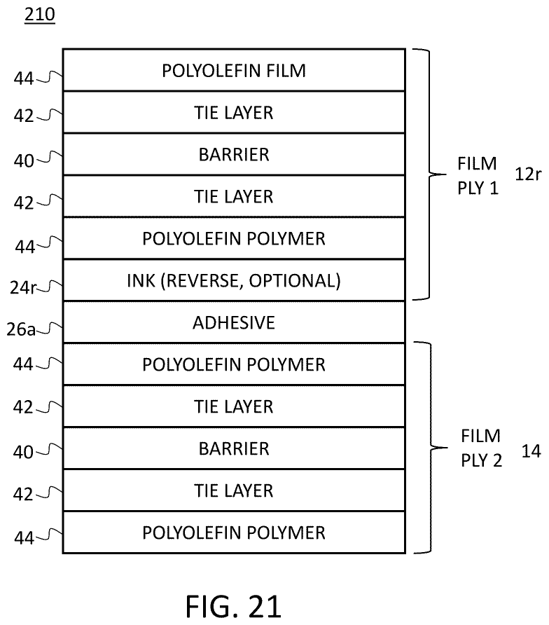

Referring now to FIG. 21, there is shown an exemplary film structure 210 having first, second, film plies 12r and 14, respectively, wherein each of the first and second film plies 12r, 14 is a coextruded film having a polymer barrier sublayer 40 within a multilayer coextruded film.

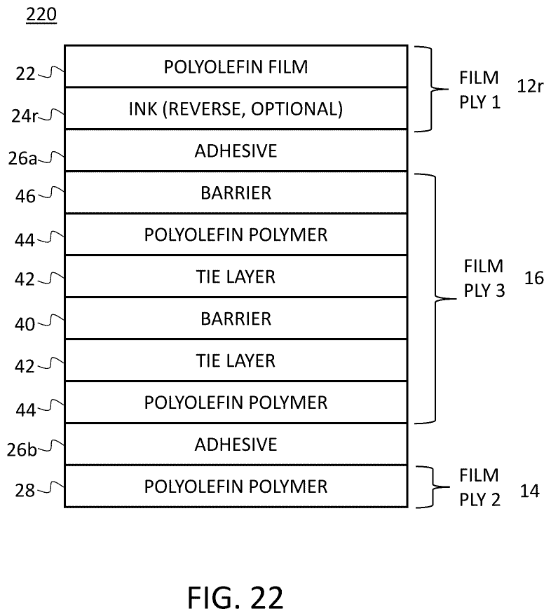

Referring now to FIG. 22, there is shown an exemplary film structure 220 having first, second, and third film plies 12r, 14, and 16, respectively, wherein the third film ply 16 includes a barrier coating layer 46 disposed a first side of a polyolefin layer 44 and the second film ply 14 comprises a barrier coating layer 46 disposed a first side of a coextruded film having a polymer barrier sublayer 40.

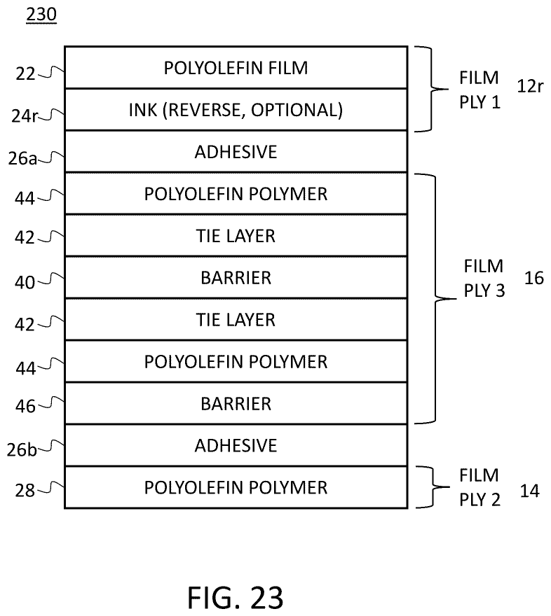

Referring now to FIG. 23, there is shown an exemplary film structure 230 having first, second, and third film plies 12r, 14, and 16, respectively, wherein the third film ply 16 includes a barrier coating layer 46 disposed a second side of a polyolefin layer 44 and the second film ply 14 comprises a barrier coating layer 46 disposed a first side of a coextruded film having a polymer barrier sublayer 40.

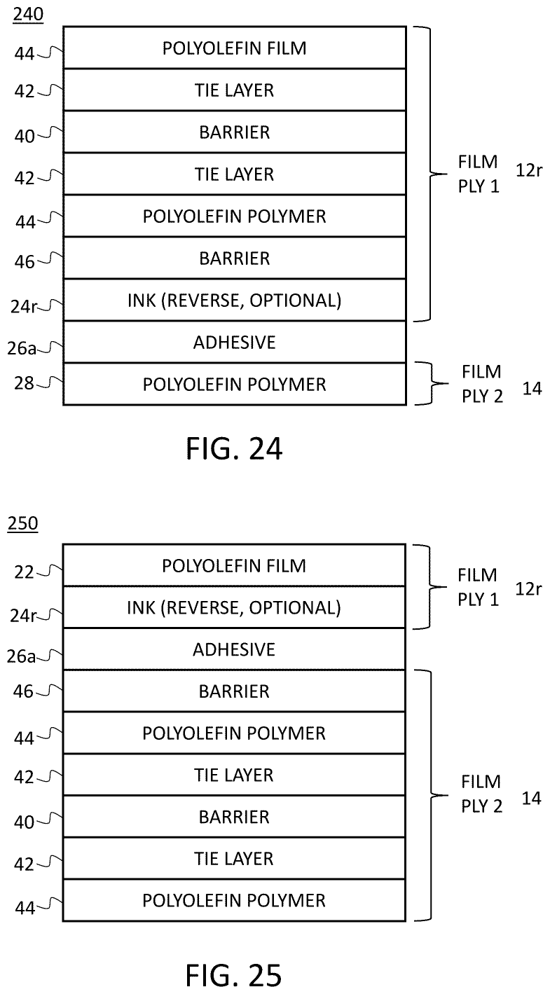

Referring now to FIG. 24, there is shown an exemplary film structure 240 having first and second film plies 12r and 14, respectively, wherein the first film ply 12r includes a barrier coating layer 46 disposed a second side of a coextruded film having a polymer barrier sublayer 40.

Referring now to FIG. 25, there is shown an exemplary film structure 250 having first and second film plies 12r and 14, respectively, wherein the second film ply 14 includes a barrier coating layer 46 disposed a first side of a coextruded film having a polymer barrier sublayer 40.

The invention has been described with reference to the preferred embodiment. Modifications and alterations will occur to others upon a reading and understanding of the preceding detailed description. It is intended that the invention be construed as including all such modifications and alterations insofar as they come within the scope of the appended claims or the equivalents thereof.

1. A recyclable, laminated polyolefin film structure comprising:
a first film ply comprising a first polyolefin film comprising one or more polyolefin polymers selected from the group consisting of polyolefin homopolymers, copolymers, and terpolymers and mixtures thereof, the first polyolefin film having a first surface and a second surface opposite the first surface;
a second film ply comprising a second polyolefin film comprising one or more polyolefin polymers selected from the group consisting of polyolefin homopolymers, copolymers, and terpolymers and mixtures thereof, the second polyolefin film having a multilayer structure, wherein the second polyolefin film comprises a first surface and a second surface opposite the first surface, the second surface of the second polyolefin film comprising a sealant layer and defining an innermost surface of the laminated polyolefin film;
an adhesive layer interposed between the first film ply and the second film ply, the adhesive layer laminating the first film ply to the third film ply, wherein the first surface of the second polyolefin film faces the first surface of the first polyolefin film; and
wherein the first film ply, the second film ply, or both, include one or more barrier layers.

2. The laminated polyolefin film structure of claim 1, wherein the one or more barrier layers comprises a first barrier coating layer on the first polyolefin film and a second barrier coating layer on the second polyolefin film.

3. The laminated polyolefin film structure of claim 2, wherein the first barrier coating layer is disposed on at least one of the first surface and the second surface of the first polyolefin film and the second barrier coating layer is disposed on at least one of the first surface and the second surface of the second polyolefin film.

4. The laminated polyolefin film structure of claim 2, wherein the first and second barrier coating layers, which may be the same or different, are selected from the group consisting of an organic barrier coating layer, polyvinyl alcohol (PVOH), an inorganic barrier coating layer, a metal oxide coating layer, aluminum oxide (AlOx, silicon oxide (SiOx), and a metalized coating layer.

5. (canceled)

6. The laminated polyolefin film structure of claim 1, wherein the first polyolefin film comprises a first coextruded film and the second polyolefin film comprises a second coextruded film, and wherein the one or more barrier layers comprises a first polymer barrier sublayer of the first coextruded film and a second polymer barrier sublayer of the second coextruded film, wherein the first and second polymer barrier sublayers, which may be the same or different, are formed of a polymer selected from the group consisting of ethylene-vinyl alcohol (EVOH), polyvinyl alcohol (PVOH), and a polyamide.

7. (canceled)

8. The laminated polyolefin film structure of claim 6, wherein the first and second polymer barrier sublayers are formed of EVOH.

9. The laminated polyolefin film structure of claim 1, wherein the first polyolefin film comprises a coextruded film, and wherein the one or more barrier layers comprises a polymer barrier sublayer of the coextruded film and a barrier coating layer disposed on the second polyolefin film.

10-11. (canceled)

12. The laminated polyolefin film structure of claim 1, wherein the second polyolefin film comprises a coextruded film, and wherein the one or more barrier layers comprises a barrier coating layer disposed on the first polyolefin film and a polymer barrier sublayer of the coextruded film.

13-14. (canceled)

15. The laminated polyolefin film structure of claim 1, wherein the first polyolefin film comprises a coextruded film, and wherein the one or more barrier layers comprises a polymer barrier sublayer of the coextruded film and a barrier coating layer disposed on at least one of the first and second surfaces of the first polyolefin film.

16-17. (canceled)

18. The laminated polyolefin film structure of claim 1, wherein the second polyolefin film comprises a coextruded film, and wherein the one or more barrier layers comprises a polymer barrier sublayer of the coextruded film and a barrier coating layer disposed on a surface of the second polyolefin film.

19-20. (canceled)

21. The laminated polyolefin film structure of claim 1, further comprising a printed layer disposed intermediate the first polyolefin film and the second polyolefin film.

22. The laminated polyolefin film structure of claim 21, wherein the printed layer comprises a reverse printed ink layer disposed on the second surface of the first polyolefin film.

23. A package formed of the laminated polyolefin film structure of claim 1.

24. A recyclable, laminated polyolefin film structure comprising:
a first film ply comprising a first polyolefin film comprising one or more polyolefin polymers selected from the group consisting of polyolefin homopolymers, copolymers, and terpolymers and mixtures thereof, the first polyolefin film having a first surface and a second surface opposite the first surface;
a second film ply comprising a second polyolefin film comprising one or more polyolefin polymers selected from the group consisting of polyolefin homopolymers, copolymers, and terpolymers and mixtures thereof, the second polyolefin film having a multilayer structure, wherein the second polyolefin film comprises a first surface and a second surface opposite the first surface, the second surface of the second polyolefin film comprising a sealant layer and defining an innermost surface of the laminated polyolefin film;
a third film ply interposed between the first film ply and the second film ply, the third film ply comprising a third polyolefin film comprising one or more polyolefin polymers selected from the group consisting of polyolefin homopolymers, copolymers, and terpolymers and mixtures thereof, the third polyolefin film having a first surface and a second surface opposite the first surface;
a first adhesive layer interposed between the first film ply and the third film ply, the first adhesive layer laminating the first film ply to the third film ply, wherein the first surface of the third polyolefin film faces the second surface of the first polyolefin film;
a second adhesive layer interposed between the third film ply and the second film ply, the second adhesive layer laminating the third film ply to the second film ply, wherein the first surface of the second polyolefin film faces the second surface of the third polyolefin film; and
wherein one or more of the first film ply, the second film ply, and the third film ply includes one or more barrier layers.

25. The laminated polyolefin film structure of claim 24, wherein the one or more barrier layers comprises a first barrier coating layer on the third polyolefin film and a second barrier coating layer on the second polyolefin film.

26. The laminated polyolefin film structure of claim 25, wherein the first barrier coating layer is disposed on at least one of the first surface and the second surface of the third polyolefin film and the second barrier coating layer is disposed on at least one of the first surface and the second surface of the second polyolefin film.

27. The laminated polyolefin film structure of claim 25, wherein the first and second barrier coating layers, which may be the same or different, are selected from the group consisting of an organic barrier coating layer, polyvinyl alcohol (PVOH), an inorganic barrier coating layer, a metal oxide coating layer, aluminum oxide (AlOx, silicon oxide (SiOx), and a metalized coating layer.

28. (canceled)

29. The laminated polyolefin film structure of claim 24, wherein the third polyolefin film comprises a first coextruded film and the second polyolefin film comprises a second coextruded film, and wherein the one or more barrier layers comprises a first polymer barrier sublayer of the first coextruded film and a second polymer barrier sublayer of the second coextruded film; and wherein the first and second polymer barrier sublayers, which may be the same or different, are formed of a polymer selected from the group consisting of ethylene-vinyl alcohol (EVOH), polyvinyl alcohol (PVOH), and a polyamide.

30-31. (canceled)

32. The laminated polyolefin film structure of claim 24, wherein the third polyolefin film comprises a coextruded film, and wherein the one or more barrier layers comprises a polymer barrier sublayer of the coextruded film and a barrier coating layer disposed on the second polyolefin film.

33-34. (canceled)

35. The laminated polyolefin film structure of claim 24, wherein the second polyolefin film comprises a coextruded film, and wherein the one or more barrier layers comprises a barrier coating layer disposed on the third polyolefin film and a polymer barrier sublayer of the coextruded film.

36-37. (canceled)

38. The laminated polyolefin film structure of claim 24, wherein the third polyolefin film comprises a coextruded film, and wherein the one or more barrier layers comprises a polymer barrier sublayer of the coextruded film and a barrier coating layer disposed on at least one of the first and second surfaces of the third polyolefin film.

39-40. (canceled)

41. A package formed of the laminated polyolefin film structure of claim 24.
